(19) United States
(12) Patent Application Publication
(10) Pub. No.: US 2014/0060840 A1
(43) Pub. Date: Mar. 6, 2014

(54) ALTERING A COMPOSITION AT A LOCATION ACCESSED THROUGH AN ELONGATE CONDUIT

(71) Applicants: Robert Seth Hartshorne, Burwell (GB); Andrew Meredith, Cambridge (GB); Nathan Lawrence, Wynton (GB)

(72) Inventors: Robert Seth Hartshorne, Burwell (GB); Andrew Meredith, Cambridge (GB); Nathan Lawrence, Wynton (GB)

(73) Assignee: SCHLUMBERGER TECHNOLOGY CORPORATION, SUGAR LAND, TX (US)

(21) Appl. No.: 14/116,567

(22) PCT Filed: May 10, 2012
(86) PCT No.: PCT/IB2012/052334

§ 371 Date: Nov. 8, 2013

(30) Foreign Application Priority Data
May 18, 2011 (GB) 1108274.0

(51) Int. Cl. C09K 8/58

(52) U.S. Cl. CPC C09K 8/58
USPC 166/300

(57) ABSTRACT

A composition flowing along an elongate conduit to a location accessed by that conduit contains a precursor substance which, arriving at the location, is converted electrochemically to chemically reactive intermediate. This intermediate reacts with another constituent of the composition, thereby bringing about a change in the composition. The reactive intermediate may be a cross-linking agent for a polymeric constituent of the composition so that the electrochemical reaction and subsequent cross-linking increases the viscosity of the composition as it arrives at the location where it is required.

### FIELD AND BACKGROUND

This invention is concerned with a method to bring about a change in a fluid at a location accessed through an elongate conduit. In some embodiments of this invention such a conduit may be a wellbore or pipework. The location may be below the Earth's surface. Embodiments of the invention are applicable, in particular, when the subterranean location is accessible from the surface by a wellbore and the fluid is pumped from the surface to the subterranean location.

It is well known to pump a fluid down a wellbore to an underground location, in a procedure where the fluid is formulated to contain reacting materials intended to react in the vicinity of the underground location and thereby change the properties of fluid after a period of transit down wellbore. For example Society of Petroleum Engineers paper SPE121759 discusses delayed cross-linking and a number of issues associated with securing the desired length of delay.

There have been a very limited number of proposals to make use of an electrochemical change in connection with fluid flowing through a wellbore.

U.S. Pat. No. 2,801,697 published in 1957 proposed that corrosion inhibiting ions are liberated from a metal electrode located at the bottom of the wellbore, so that these ions would be present in brine carried up the wellbore as hydrocarbon is produced.

US 2004/0180793 discloses an electrochemical cell located on the exterior of wellbore casing to liberate hydrogen gas by electrolysis of water during cementing and thereby create a small fluid pressure channel through the cement.

### SUMMARY

Broadly the subject matter disclosed here provides a method of altering a composition at a location accessed through an elongate conduit by effecting an electrochemical reaction of a substance present at that location, thereby converting that substance into a reaction product within the composition. In forms of this invention, the reaction product within the composition undergoes further chemical reaction within the composition while it is at the location. Thus in a first aspect this provides a method of altering a composition at a location accessed through an elongate conduit, the method comprising effecting an electrochemical reaction of a precursor substance present at the said location, thereby converting that precursor substance into an intermediate product which then undergoes reaction with at least one other constituent of the composition.

The location may be a subterranean location accessed by a wellbore extending from the surface. In this case the subterranean location may be within the wellbore itself or may be in the formation around the wellbore. It may be at the transition between the two where fluids pass from the wellbore into the formation or vice versa. The wellbore may give access to a hydrocarbon reservoir, or to an aquifer, to geothermal fluid or to a formation used to store captured carbon dioxide.

Another possibility, in some embodiments, is that the location for the electrochemical reaction may be within pipework, possibly pipework which extends underground or underwater.

In some embodiments the said location may be at a distance of at least 100 metres along the conduit from a point giving access to the conduit, for instance from the head of a wellbore or from one end of a run of pipework. The distance may possibly be considerably more than 100 metres, for instance 500 metres or even more.

The electrochemical reaction will be brought about by applying electrical potential to a plurality of electrodes in contact with the composition at the location. It is possible that one or more electrodes might be constituted by steel structure of the wellbore or other conduit. However, in general at least one electrode will be formed from conducting material insulated from the structure of the wellbore or other conduit and provided with a supply of electrical power.

Electrochemical conversion will take place in the vicinity of the electrodes and so the position of the electrodes will determine where the electrochemical conversion takes place.

One possibility for electrode design would be to use tubular electrode, located so that the composition containing the precursor substance passed through this tubular electrode at the location. Another possibility would be to use an electrode in the form of a mesh or gauze placed so that the composition containing the precursor substance is made to pass through the apertures in the mesh. In some embodiments the composition may flow through apertures in a mesh as it flows out through perforations in a wellbore into the surrounding formation.

The precursor substance which undergoes electrochemical conversion may be provided as a constituent of the composition and the invention may comprise a step of pumping a composition containing said precursor substance from the surface to the location where it undergoes electrochemical reaction. It is envisaged that this precursor and the intermediate product formed from it may be organic chemicals. Thus the precursor molecule may comprises a plurality of carbon atoms connected together (for instance as a ring and/or a chain) and at least one functional group attached thereto. The electrochemical reaction may perhaps then alter at least one functional group while the structure of connected carbon atoms remains intact.

The reaction of the intermediate product may lead to a change in physical properties of the fluid. One possibility is that the reaction of the intermediate with one or more other constituents of the composition is a reaction which couples relatively large entities together. This may serve to amplify the effect of the electrochemical conversion so that a substantial change in physical properties is brought about by a modest amount of electrochemical action.

In some embodiments, the composition is a fluid which is thickened with a viscosifying polymer and the intermediate serves to cross-link the polymer and thereby increase the viscosity of the composition. So, some forms of the method of this invention may be stated as a method of increasing the viscosity of a fluid at a location accessed by a wellbore by cross-linking a thickening polymer in the fluid, comprising effecting an electrochemical reaction, at the said location, of a precursor substance present in the fluid, thereby converting that precursor substance into an intermediate product which is a cross-linking agent for the thickening polymer.

Such embodiments may be utilized in a range of downhole operations where thickened fluids are required. Examples of downhole operations that comprise the use of viscosified fluids include hydraulic fracturing, placing chemical packers, diversion treatments, sand control treatments, control of lost-circulation, pumping in of completion fluids and workover treatments. Viscosifiers for such treatment fluids may be based on water-soluble polymers which are frequently polysaccharides of natural origin or derivatives thereof such as galactomannan gums and derivatives, cellulose derivatives and alginates. Various synthetic polymers (such as polyacrylamide) can also be used.

Aqueous solutions of hydrophilic polysaccharides at low or moderate concentrations, without crosslinking, normally show Newtonian rheological behavior. Once crosslinking between different polymer chains is introduced, the polysaccharide network may display viscoelastic and even pure-elastic behavior. Thus, the viscosity, and elasticity, of polymer-thickened solutions can be tailored, depending on application requirements, by inducing crosslinking reactions. The conventional practice of chemical crosslinking requires that a chemical crosslinking agent as incorporated into the fluid and this crosslinking agent reacts with polymer chains forming either intermolecular or intramolecular linkages between them. Chemical crosslinking reactions are highly versatile and yield crosslinked polysaccharide solutions with good mechanical and thermal stability.

However, when it is desired to bring about chemical cross-linking of a fluid pumped downhole, the control of the cross-linking reaction must necessarily be indirect. As is apparent from SPE 121759 mentioned earlier, it will be desirable that the cross-linking reaction is delayed until the fluid reaches the downhole location so as to keep the viscosity low during transit down the wellbore, yet it may be desirable that the process of cross-linking proceeds rapidly on reaching the intended location below ground. A further challenge is that in subterranean formations, a wide range of temperatures may be encountered and if the temperature of the subterranean formation is sufficiently high, the crosslinkable-polymer composition may gel prematurely. To counteract this undesirable situation arising, the crosslinkable-polymer composition must be formulated such that its gelation time is delayed or retarded. That is, the viscosifying characteristics of the crosslinkable-polymer composition must be adjusted such that the time it takes to form a crosslinked gel is delayed for a sufficient duration to permit the crosslinkable-polymer composition to be pumped to its desired destination. Although chemical gelation accelerators and retarders exist, it remains difficult to control this process and is therefore difficult to control both the initiation of the crosslinking reaction and the duration required for a crosslinkable-polysaccharide composition to generate the desired increase in fluid viscosity.

By contrast, embodiments of the present invention may provide direct control in that it initiates cross-linking at that location where cross-linking is desired. Thus it is possible to generate directly an increase in viscosity as the fluid passes through wellbore perforations out of the wellbore into the surrounding formation rather than attempting to approximate this through delay in the onset of gelation. This ability to control the development of viscosity to where it is required is useful in any circumstance where cross-linking is to be brought about downhole. However, there are several circumstances where this control of development of viscosity is especially beneficial. One of these is the placing of a settable chemical packer, for instance to temporarily close a wellbore, or close a flow path. The success of settable chemical packer operations is very dependent on the ability to generate a gel at a precise wellbore depth and with the onset of gelation occurring at a precisely controlled time. Embodiments of this invention can be used to provide this precision by placing an electrode at the location where a packer is to be formed and operating it to create cross-linking agent from a precursor substance when required.

The thickening of fluids by controlled cross-linking in accordance with this invention may be used to create slugs of gel to act as separators between other fluids and thereby prevent mixing of successive fluids by Taylor Dispersion, that is mixing arising from varying velocity profiles across the cross-section of laminar flow. In particular, when cementing a well by the conventional process of forcing cement down the wellbore casing so that it then flows back up the annulus between the wellbore casing and the surrounding formation, an embodiment of the invention may be used with electrodes at the foot of the wellbore casing to create a slug of cross-linked gel which would sweep the annulus clean ahead of the rising cement and/or to create another slug of gel after the cement to prevent the last part of the cement from mixing with the fluid pumped into the well behind the cement.

Another application of embodiments of this invention is in connection with diversion which is a used to ensure the success of matrix acid treatments. Currently chemical diversion can be achieved through placing a viscous fluid foam or gel to lower the penetration of treatment fluid into the cavities created by the acid treatment. Gelled acids may be used as a means of combining stimulation and diversion in one step. Embodiments of the present invention may be utilised to form the diverting gels and/or gelled acids through cross linking by means of a crosslinking agent formed electrochemically at the foot of the wellbore.

Some embodiments of the present invention may be used to create variations in viscosity downhole. For this purpose, a wellbore fluid containing a thickening polymer and a precursor substance capable of conversion to a cross-linking agent are pumped into a wellbore. By switching the power supply to downhole electrodes on and off at intervals or by varying the amount of electrical current supplied, the concentration of cross-linking agent generated electrochemically within the fluid downhole can be varied. This possibility may be applied when carrying out hydraulic fracturing, for instance to provide a difference between the viscosity of fluid at the toe of the fracture remote from the wellbore and the viscosity of fluid in the near wellbore region.

The invention may advantageously be employed when coiled tubing is used to deliver a fluid which is required to be thickened by cross-linking at the location to which it is delivered. One or more electrodes to bring about conversion of the precursor substance to the cross-linking agent are fitted to the outlet nozzle of the coiled tubing (the tubing itself may act as one electrode) so that the cross-linking agent is formed in the fluid as it leaves the coiled tubing. Thus it can be controlled that an increase in viscosity through cross-linking does not take place before the fluid leaves the coiled tubing.

One possibility for the electrochemistry to be employed is that the chosen thickening polymer incorporates reactive amino groups (chitosan is one such polymer) while the cross linking agent formed by electrochemical reaction is a quinone. This could be formed by electrochemical oxidation of a precursor compound with two phenolic hydroxyl groups such as catechol. This is illustrated by the following reaction scheme:

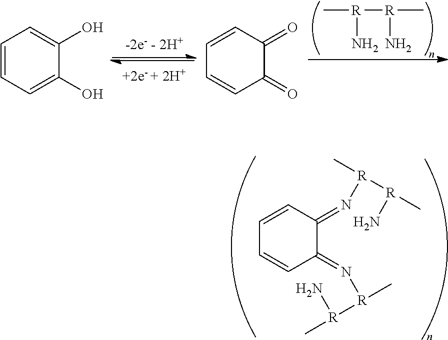

Another possibility is that cross linking could be brought about by metal ions (notably ferric ion) generated by electrochemical oxidation of a metal ion of lower valency.

It would be possible, as an embodiment of this invention, to use electrochemical reaction to convert a precursor compound to an intermediate which functions as a so-called breaker to degrade polymeric thickener and reduce viscosity when that viscosity is no longer required.

In some forms of this invention, the composition is a fluid in which solid particles are suspended. It is well-known to convey particulate materials down a wellbore to an underground location. Notably, a particulate proppant is normally placed in the fracture during hydraulic fracturing. In a somewhat similar manner, gravel is placed in a gravel pack to prevent the production of sand from a well. It is known to apply a curable resin to such particulate material, so that after the particles have been put in place they are bound together by curing of resin. A discussion of resin coatings of particulates can be found in, for example, U.S. Pat. No. 5,604,184 and U.S. Pat. No. 6,962,200.

In forms of this invention, the intermediate product produced by the electrochemical reaction is a part of the chemical system for curing the resin which binds the particulate material together. For instance it may be a catalyst or an accelerator for the curing and hardening of the resin. The particulate material which is bound together may be any of those which are currently used such as sand, gravel or fibres.

Chemistry for use in embodiments of this invention, will now be exemplified and embodiments of the invention described by way of example, in the following text and with reference to the drawings. It should be appreciated that the various features and possibilities referred to herein and illustrated by be used separately or in any operable combination and/or replaced with other chemicals or apparatus to deliver the intended functionality, within the scope of the subject matter claimed.

### BRIEF DESCRIPTION OF THE DRAWINGS

FIG. 1 illustrates an embodiment of the invention in use when carrying out fracturing of a cased well;

FIG. 2 illustrates an embodiment of the invention in use with coiled tubing which is delivering a chemical packer to form a temporary block in a wellbore;

FIG. 3 is an enlarged view of the outlet of the coiled tubing of FIG. 2;

FIG. 4 illustrates an embodiment of the invention in use when cementing; and

FIG. 5 illustrates an embodiment of the invention in use in a pipeline.

### DETAILED DESCRIPTION AND EXAMPLES

### Example 1

Electrochemical experiments were carried out using an μAutolab II potentiostat (Ecochemie, Netherlands) with a standard three-electrode configuration. A 1 mm steel rod provided the counter electrode and a saturated calomel electrode (SCE, Radiometer, Copenhagen) acted as the reference. The working electrode was a glassy carbon foam.

A solution was prepared containing 0.2 M catechol and 0.625% (wt/wt) chitosan in aqueous pH 7 phosphate buffer. An oxidative current of 5 mA was passed through the solution at ambient temperature of approximately 20° C. for one hour. The solution was stirred throughout this time, after which the solution was left to stand overnight.

On application of the current, the solution in the vicinity of the electrode immediately changed from colourless to red. Eventually, the entire solution turned dark red consistent with oxidation of catechol to the corresponding quinone. At the end of the experiment, the working electrode was removed from the solution and it was observed that a viscous gel had formed on the electrode surface. The gel was chitosan which had been crosslinked by reaction with the quinone.

In a comparison experiment the procedure was repeated with the catechol omitted. No gel formation was observed. In another comparison experiment the procedure was repeated with catechol present, but no electrical current was applied. Again no gel formation was observed.

### Example 2

A procedure with similar chemistry to the preceding example was used to demonstrate formation of a coating on the interior of tubing. A simple pipeline was formed from two stainless steel tubes (¼″ diameter) connected by a length of plastic (and therefore non-conducting) tubing. The first, smaller piece of stainless steel tubing acted as the working electrode and the second was the counter electrode. A silver wire reference electrode was then inserted into the pipeline to complete the electrochemical cell assembly.

In this case the aim of the experiment was to coat the walls of the tubing with the crosslinked gel. A solution containing 0.2 M catechol and 0.625% (wt/wt) chitosan in pH 7 phosphate buffer, as in the previous example, was placed in the pipeline and allowed to remain at rest. Upon application of the oxidative current (5 mA) the solution immediately changed colour indicating that the electrochemical reaction was occurring. The current was applied to the solution in the tubing for 1 hour and then the stainless steel tubes were examined. A gel layer of crosslinked chitosan was clearly seen on the inside wall of the first tube which had served as working electrode. This indicates a possibility of utilizing this technology for applying coatings.

### Example 3

It is known that Fe(III) (ferric) ions generated by oxidation of Fe(II) (ferrous) ions with a soluble oxidising agent (such as sodium chlorate) can bring about crosslinking of chitosan. A procedure similar to that of Example 1 was used to demonstrate cross linking by ferric ion generated electrochemically. Fe(II)sulfate was added to an aqueous solution of 1.25% (wt/wt) chitosan (in 0.1 M acetic acid). The three electrodes (working, reference and counter) as used in Example 1 were then placed into the solution and a current of 10 mA passed for 30 mins under stirred conditions. The fluid was then found to have gelled. This is consistent with the generation of Fe(III) at the electrode surface followed by chemical crosslinking of the chitosan polymer.

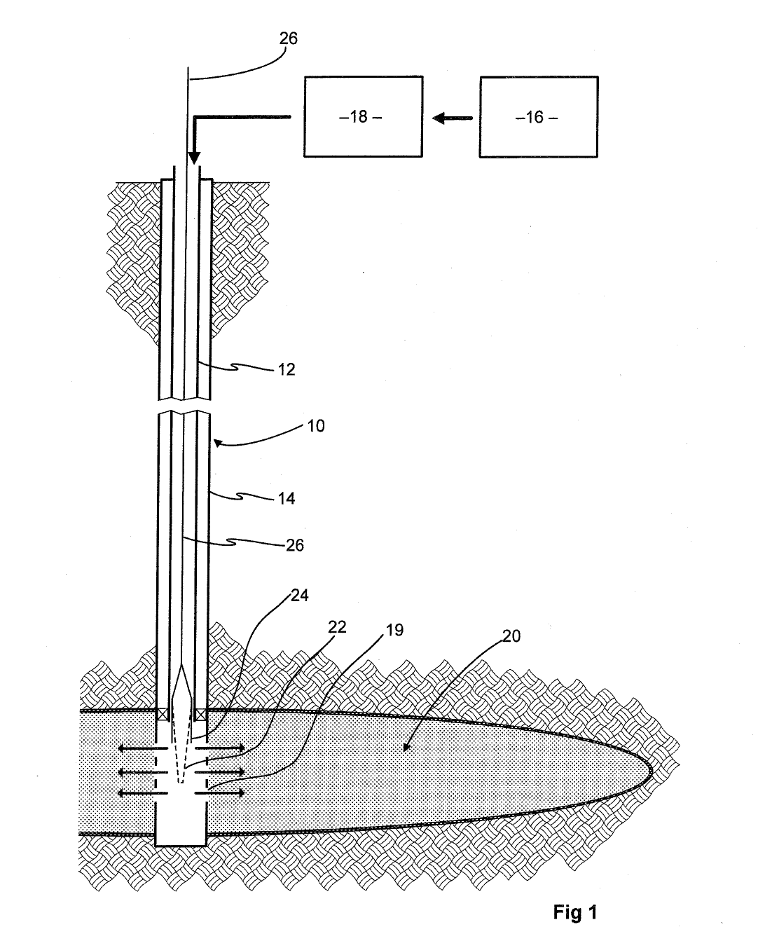

FIG. 1 illustrates an embodiment of the invention being used in a hydraulic fracturing operation. A wellbore 10 has tubing 12 located inside casing 14. Fracturing fluid which contains crosslinkable polymeric thickener, with particulate proppant suspended in the fluid, is mixed in a mixer 16 at the surface and pumped by pumps 18 into the tubing 12. At the foot of the wellbore the fracturing fluid passes through perforations 19 in the casing 14 and out into a fracture 20 as indicated by arrows.

Embodying the present invention, a conical mesh electrode 22, the upper part of which is surrounded by an electrically insulating sleeve 24, is suspended at the bottom of the tubing 12 by a wireline 26 or other cable. The mesh electrode is shaped and positioned such that at least 80% of the fracturing fluid which is pumped down the tubing 12 flows through the mesh of the electrode as it travels from the tubing 12 into the fracture 20.

The fracturing fluid is formulated to contain a precursor substance. Electrical potential is supplied to the mesh electrode 22 via the cable 26. The tubing 12 and casing 14 serve as counter electrode. The precursor substance undergoes electrochemical conversion as it passes through the mesh electrode 22 and is converted to an intermediate product which is a cross-linking agent for the polymer in the fluid. Consequently cross-linking of the polymer is caused to commence as the fluid flows from the tubing 12 into the fracture 20.

An arrangement such as that shown in FIG. 1 could also be used to convert a precursor substance to an intermediate which then causes the curing of a resin coating on particulate proppant suspended in the fracturing fluid.

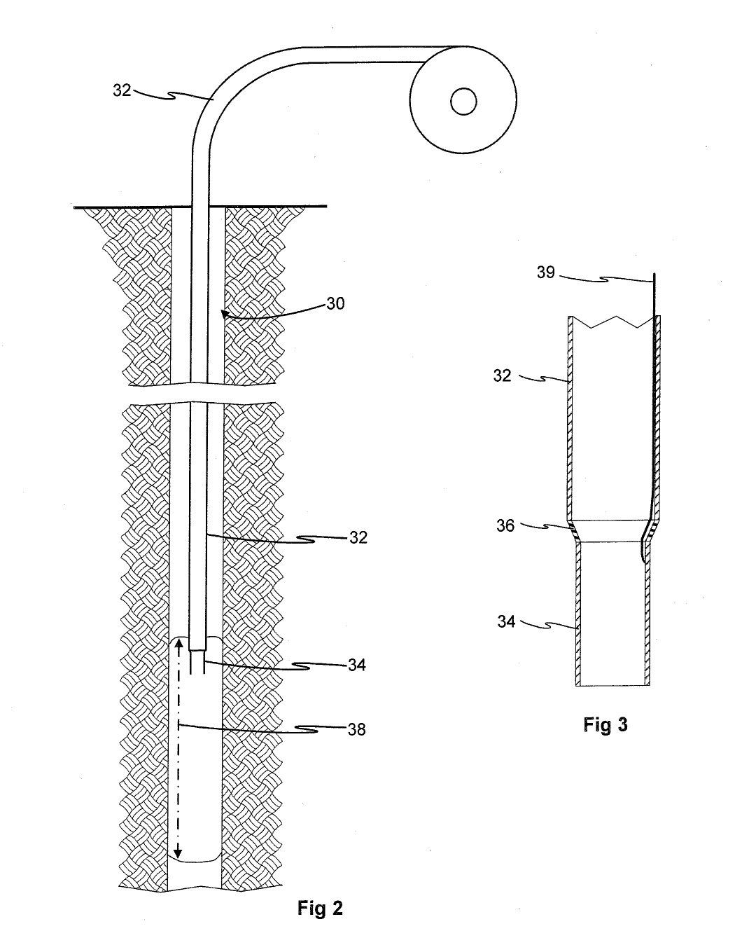

FIG. 2 shows an arrangement in which a composition is delivered down a wellbore 30 to a subterranean location by means of coiled tubing 32. The purpose is to form a chemical packer. As shown by the larger scale FIG. 3, a nozzle 34 is attached to the end of the coiled tubing by a short section 35 formed of electrically insulating material. A composition containing a precursor substance is supplied down the coiled tubing from the surface. The coiled tubing 32 serves as the counter electrode and potential is applied to the nozzle 34, as working electrode, through a cable 36 inside the coiled tubing. The precursor substance in the composition undergoes electrochemical conversion as it passes through the nozzle 34 and is converted to an intermediate product which is a crosslinking agent for a polymer in the composition which is being supplied along the coiled tubing 32. The polymer becomes cross linked to a very viscous state which blocks the wellbore in the region 38 below the nozzle 34.

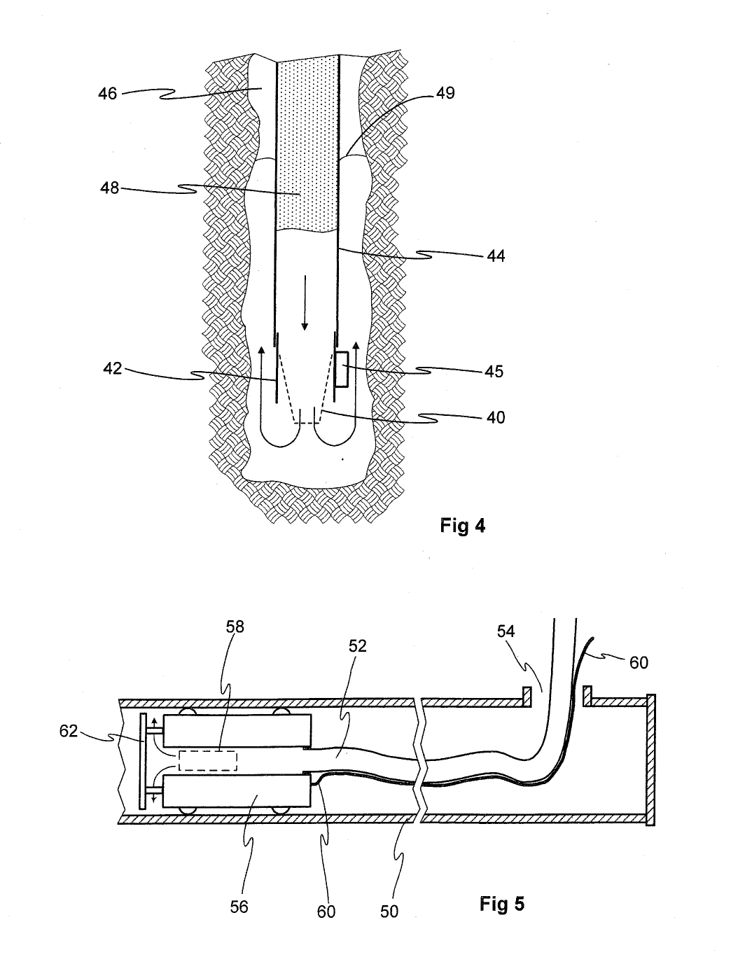

FIG. 4 shows an embodiment of the invention used when cementing. A mesh electrode 40 inside a short section of electrically insulating material 42 at the foot of tubing 44 is supplied with electrical potential by a one-time-only battery pack 45 which is turned on when required by an acoustic signal from the surface. An aqueous composition containing crosslinkable polymer and a precursor for a crosslinking agent is pumped down the tubing 44 ahead of a pumpable cement composition 48. The precursor is converted electrochemically to cross linking agent as it passes through the mesh electrode 40 and this cross links the polymer and thickens the composition to a slug of higher viscosity gel as it turns at the foot of tubing 44 and is then driven up the annulus 46 ahead of the cement 48. The leading end of the slug of gel is indicated at 49.

FIG. 5 shows an embodiment of the invention used within a long rigid pipeline 50. A composition is supplied along a flexible pipe 52 which enters the pipeline 50 through opening 54 at one end and extends for 100 meters or more along the pipeline to a tractor 56 movable within the pipeline. As the flowing composition flows along a central passage through the tractor 56 it passes through a mesh electrode 58. The pipeline itself provides a counter electrode. A power supply to the tractor 56 and the mesh electrode 58 is provided by cable 60 at the exterior of the flexible pipe 52. A baffle 62 forces the flowing composition out to the wall of pipeline 50.

A precursor substance in the flowing composition is converted electrochemically into a reactive intermediate product as the composition passes through the mesh electrode 58 and the resulting intermediate reacts with another constituent of the composition to form a material which deposits as a coating on the interior of the pipeline 50.

The arrangement shown in FIG. 5 could be used in similar fashion to the arrangement shown in FIG. 2 to cause the crosslinking of a polymer solution delivered along the flexible pipe 52 and form a plug of crosslinked polymer in the pipeline as a temporary block, prior to pipeline repair. As in the arrangement shown in FIG. 2, the polymer composition supplied along flexible pipe 52 contains a precursor substance converted electrochemically to a crosslinking agent for the polymer.

1. A method of altering a composition at a location accessed through an elongate conduit which comprises
providing a composition containing a precursor substance and at least one other constituent
wherein the precursor substance is an organic chemical whose molecule comprises a plurality of carbon atoms connected together and at least one functional group attached thereto;
effecting an electrochemical reaction of the precursor substance present at the said location to alter at least one said functional group of the precursor substance, thereby converting that precursor substance into an intermediate product which then undergoes reaction with at least one other constituent of the composition.

2. A method according to claim 1 wherein the location is an underground location accessed by a wellbore.

3. A method according to claim 1 wherein the location is inside pipework.

4. A method according to claim 1, wherein the distance along the conduit to the location from an access opening is at least 100 meters.

5. A method according to claim 1 further comprising c containing said precursor substance within the conduit to the said location.

6. A method according to claim 1 further comprising pumping a composition containing said other constituent within the conduit to the said location.

7. A method according to claim 1 further comprising pumping a fluid composition containing both said precursor substance and said other constituent within the conduit to the said location.

8. (canceled)

9. A method according to claim 1 wherein the composition is a fluid and the electrochemical reaction leads to a change in physical properties of the fluid

10. A method according to claim 1 wherein the composition is a fluid which contains a viscosifying polymer and the intermediate product cross links the polymer thereby increasing the viscosity of the fluid.

11. A method according to claim 1 wherein the composition comprises a fluid and solid particles suspended therein, which particles carry a curable coating, and the intermediate product accelerates cure of the coating.

12. A method according to claim 1 wherein the at least one other constituent of the composition comprises a cross linkable polymer and the intermediate product reacts with the polymer by cross-linking the polymer.

13. A method of altering a composition at an underground location accessed by a wellbore, comprising
pumping a fluid composition containing a precursor substance and at least one other constituent down the wellbore to the underground location,
wherein the precursor substance is an organic chemical whose molecule comprises a plurality of carbon atoms connected together and at least one functional group attached thereto and the at least one other substance comprises a crosslinkable polymer;
effecting an electrochemical reaction of the precursor substance at the said location to alter at least one said functional group of the precursor substance, thereby converting that precursor substance into an intermediate product which brings about crosslinking of the polymer thereby increasing the viscosity of the fluid.

14. A method according to claim 13 wherein the crosslinkable polymer comprises amino groups and the precursor substance comprises phenolic hydroxyl groups which are converted to keto groups by the electrochemical reaction and then react with the amino groups of the polymer.

15. A method according to claim 13 wherein the crosslinkable polymer comprises amino groups and the precursor substance comprises ferrous ions which are converted to ferric ions by the electrochemical reaction and then react with the amino groups of the polymer.

16. A method according to claim 13 wherein the fluid with viscosity increased by crosslinking is one of a chemical packer, a diverting fluid and a hydraulic fracturing fluid.

16. A method of altering a composition at an underground location accessed by a wellbore, comprising
pumping a fluid composition containing a precursor substance and suspended solid particles coated with a curable resin down the wellbore to the underground location,
wherein the precursor substance is an organic chemical whose molecule comprises a plurality of carbon atoms connected together and at least one functional group attached thereto; and
effecting an electrochemical reaction of the precursor substance at the said location to alter at least one said functional group of the precursor substance, thereby converting that precursor substance into an intermediate product which is a catalyst or accelerator for curing of the resin.
